(19) United States
(12) Patent Application Publication
(10) Pub. No.: US 2026/0356068 A1
(43) Pub. Date: Nov. 12, 2026

(54) ROBOTIC CARTON FORMING SYSTEM

(71) Applicant: Pacteon Corporation, Brewerton, NY (US)

(72) Inventors: Michael Morgan, Blacksburg, VA (US); Michael Smith, Blacksburg, VA (US); Paul Landers, Blacksburg, VA (US)

(21) Appl. No.: 19/122,955

(22) PCT Filed: Oct. 23, 2023
(86) PCT No.: PCT/US2023/077534

§ 371 Date: Apr. 21, 2025

Related U.S. Application Data
(60) Provisional application No. 63/418,260, filed on Oct. 21, 2022.

(51) Int. Cl. B31B 50/00; B31B 50/06; B31B 50/07; B31B 50/26; B31B 110/35

(52) U.S. Cl. CPC B31B 50/006; B31B 50/066; B31B 50/07; B31B 50/26; B31B 2110/35

(57) ABSTRACT

A system and associated method and computer program product for robotically forming a carton includes a carton assembly station which includes a minor flap folding station having a minor flap platform upon which minor flaps of the carton can be robotically folded, a transfer shelf positioned adjacent the minor flap folding station and configured to support the carton with the minor flaps folded, and a major flap folding station having a major flap platform upon which a major flap of the carton can be robotically folded.

### CROSS-REFERENCE TO RELATED APPLICATION

The present application relates and claims priority to U.S. Provisional Patent Application No. 63/418,260, filed Oct. 21, 2022, the entirety of which is hereby incorporated by reference.

### FIELD OF THE INVENTION

The present disclosure is directed generally to machines/systems for forming cartons.

### BACKGROUND

Packaging science involves, among other things, efficient processes for forming boxes, cartons, and other packaging structures. Robots programmed to perform repetitive tasks associated with the folding of paperboard and other materials into predefined shaped cartons is a common engineering solution for increased productivity and enhanced quality control. Robots can be programmed to take a paperboard blank, fold it along predefined creases, move and secure bottom flaps, place an object in the package, and finally fold a top flap(s) to enclose the package. Glue, tape, or another sealant can be applied automatically to secure the package.

Typically, a robot will pick a paperboard blank from a magazine and rotate/move the blank across fixed plates shaped and positioned to form the particular stage of the carton. A servomotor driven belt will move the carton along stations where further fixed plates are positioned and the carton is drawn across them to move the various flaps into the final form of a carton. A servo-driven pusher arm or pick and place robot arm will move products into the carton and a final stage of sealing the carton shut will be applied to fully package the product.

The numerous moving parts in such an assembly require frequent maintenance, and the assembly line takes up significant space.

Accordingly, there is a need in the art for a robotic carton assembly system that minimizes the number of moving parts and decreases the assembly line footprint.

### SUMMARY

The present disclosure is directed to a robotic carton forming system.

According to an aspect is a method for robotically forming a carton using a robot having a processor with non-transitory memory in which is stored a program of instructions executable by the processor to perform the method, wherein the method comprises the steps of robotically picking a carton blank from a magazine, the carton blank comprising a carton body, at least two minor flaps and at least one major flap; robotically forming the carton body from the carton blank; robotically moving the carton to a minor flap folding station and robotically folding the minor flaps of the carton with respect to the carton body; robotically moving the carton to a major flap folding station and robotically folding the major flap of the carton with respect to the carton body; and verifying that the carton is formed.

According to an aspect is a system for robotically forming a carton, comprising a carton assembly station which comprises a minor flap folding station having a minor flap platform upon which minor flaps of the carton can be robotically folded; a transfer shelf positioned adjacent the minor flap folding station and configured to support the carton with the minor flaps folded; a major flap folding station having a major flap platform upon which a major flap of the carton can be robotically folded; and the system further comprises a robot having a processor with non-transitory memory in which is stored a program of instructions executable by the processor and which when executed cause the carton to be formed.

According to an embodiment, the program of instructions performs a method when executed, the method comprises the following steps robotically picking a carton blank from a magazine, the carton blank comprising a carton body, at least two minor flaps and at least two major flaps; robotically forming the carton body from the carton blank; robotically moving the carton to a minor flap folding station and robotically folding the minor flaps of the carton with respect to the carton body; robotically moving the carton to a major flap folding station and robotically folding the major flaps of the carton with respect to the carton body; and verifying that the carton is formed.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a flow chart of a robotic carton assembly process, in accordance with an embodiment.

FIGS. 2A and 2B are perspective views of a robot carton assembly system, in accordance with an embodiment.

FIG. 3 is a perspective view of a robot picking a carton blank from a magazine, in accordance with an embodiment.

FIG. 4 is a perspective view of a robot with extended tooling after picking a carton blank, in accordance with an embodiment.

FIG. 5 is a perspective view of a robot with retracted tooling after picking a carton blank, in accordance with an embodiment.

FIG. 6 is a perspective view of a robot carton assembly system in a first large carton forming angle, in accordance with an embodiment.

FIG. 7 is a perspective view of a robot carton assembly system in a second large carton forming angle, in accordance with an embodiment.

FIG. 8 is a perspective view of a robot carton assembly system in a third large carton forming angle, in accordance with an embodiment.

FIG. 9 is a perspective view of a robot carton assembly system in a first small carton forming angle, in accordance with an embodiment.

FIG. 10 is a perspective view of a robot carton assembly system in a second small carton forming angle, in accordance with an embodiment.

FIG. 11 is a perspective view of a robot carton assembly system in a third small carton forming angle, in accordance with an embodiment.

FIG. 12 is a perspective view of a robot carton assembly system in a third small carton forming angle, in accordance with an embodiment.

### DETAILED DESCRIPTION OF EMBODIMENTS

The present disclosure describes a multi-axis robot (more specifically, a robotic arm) carton assembly system.

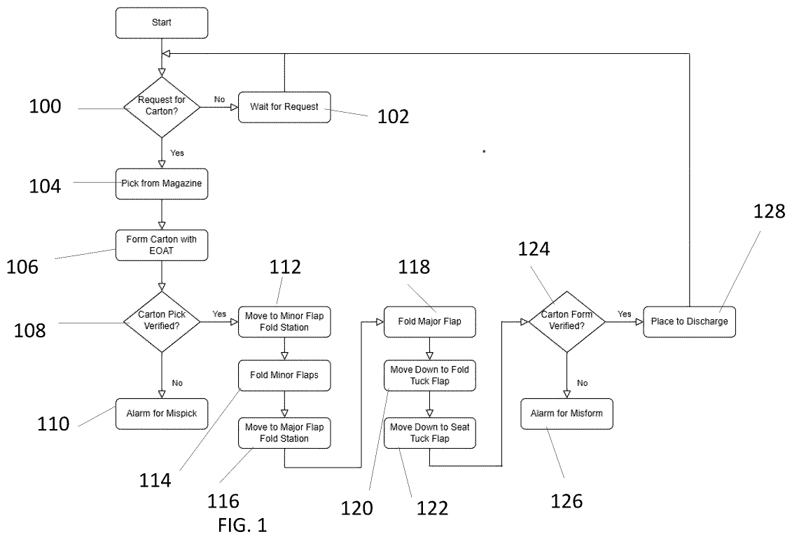

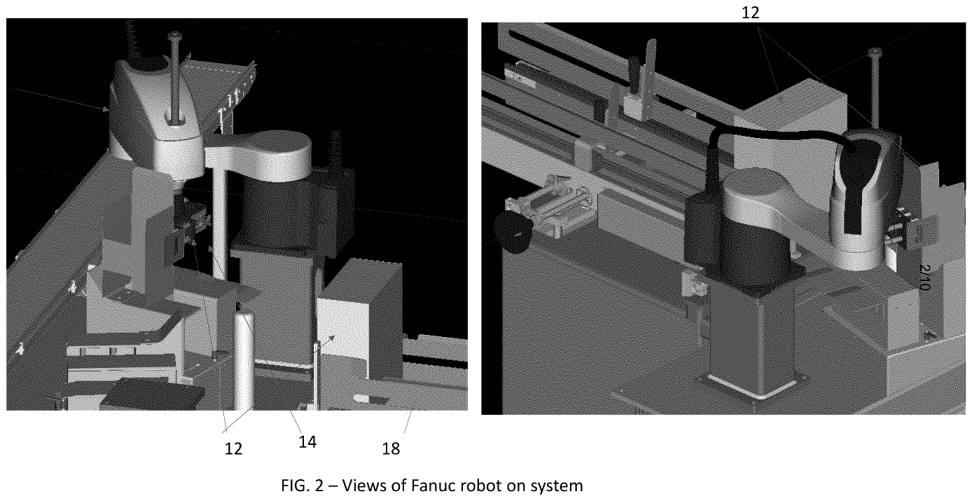

Referring to FIG. 1, in one embodiment, is a flow chart of a robotic carton assembly process. The robot carton assembly system, which will be described hereinafter, includes a robot 10 that has been programmed, configured, and/or structured to perform the process reflected in FIG. 1. First, a robot 10 will check if there has been a request for a carton in step 100. If not, it waits in step 102 and then checks for a request again in step 100 repeating this loop until a request has been made. Once a request has been made, the robot 10 will pick a carton blank 12 from a magazine in step 104 using pneumatics and a vacuum cup to pick a pre-glued carton blank from a static position. The carton is then formed using tooling 14 mounted on the end of the robot (arm) 16 in step 106. Next, it is verified whether a carton pick has been successful in step 108, and if not, an alarm is sounded for a mispick in step 110 (and manual intervention is needed to correct the mispick). If the pick is verified, then the robot moves about its axes and the carton moved to a minor flap fold station in step 112. The tooling on the end of the robot 10 then folds the minor flaps in step 114 and the carton moved to the major flap folding station in step 116. The tooling 14 and robot 10 then proceeds to fold the major flap(s) in step 118 followed by moving down to fold the tuck flap in step 120 and moving down to seat the tuck flap in step 122. A sensor then acts to verify the form of the carton in step 124 and if not properly formed an alarm is triggered to alert for the misform in step 126 (and manual intervention is needed), and if properly formed, tooling 14 and robot 10 place the formed carton for discharge in step 128. The above process then repeats for as many cycles as needed to form all cartons.

Robot 10 is a commercially available, programmable robot, such as a FANUC® robot manufactured by FANUC America Corporation, that is adapted with tooling 14 attached at the end of the robot arm 16. Tooling 14 comprises.

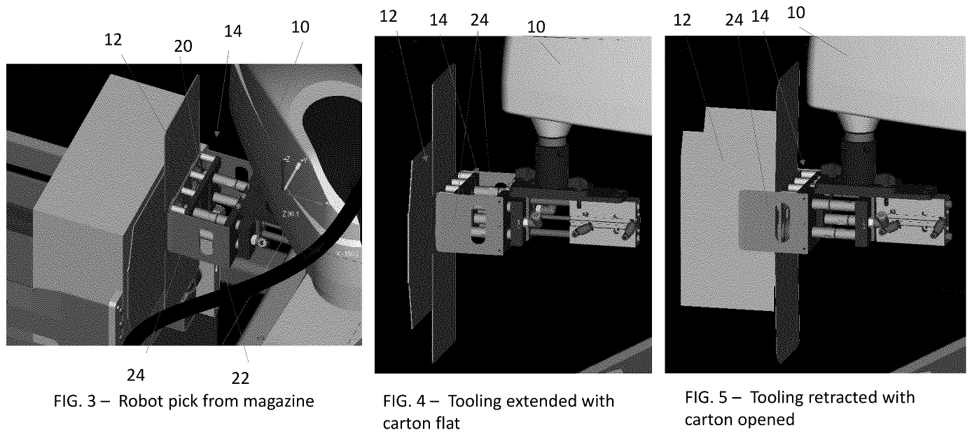

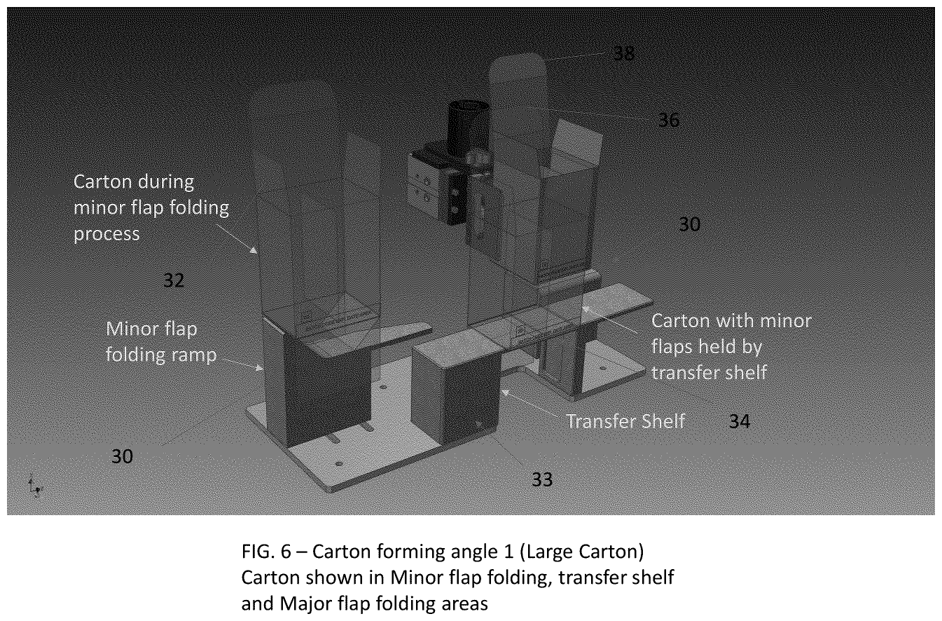

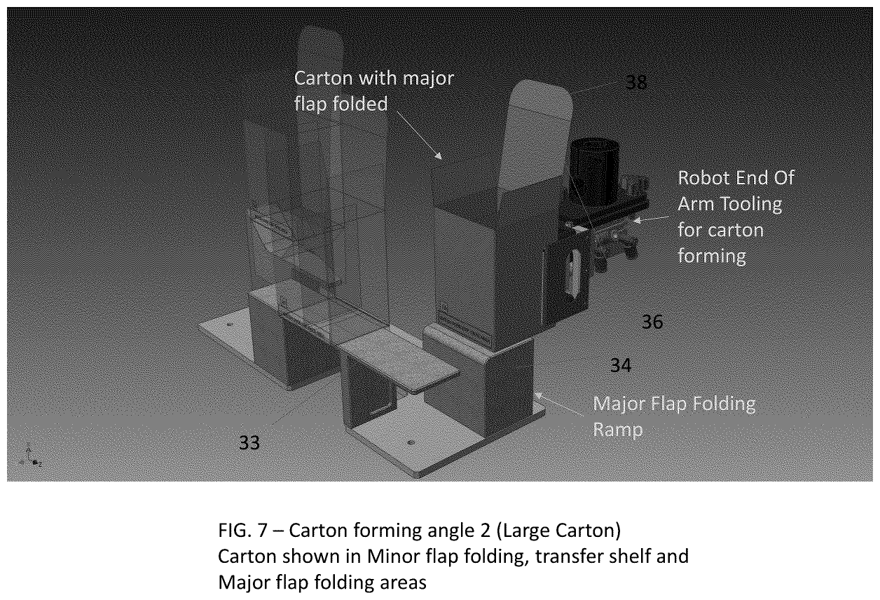

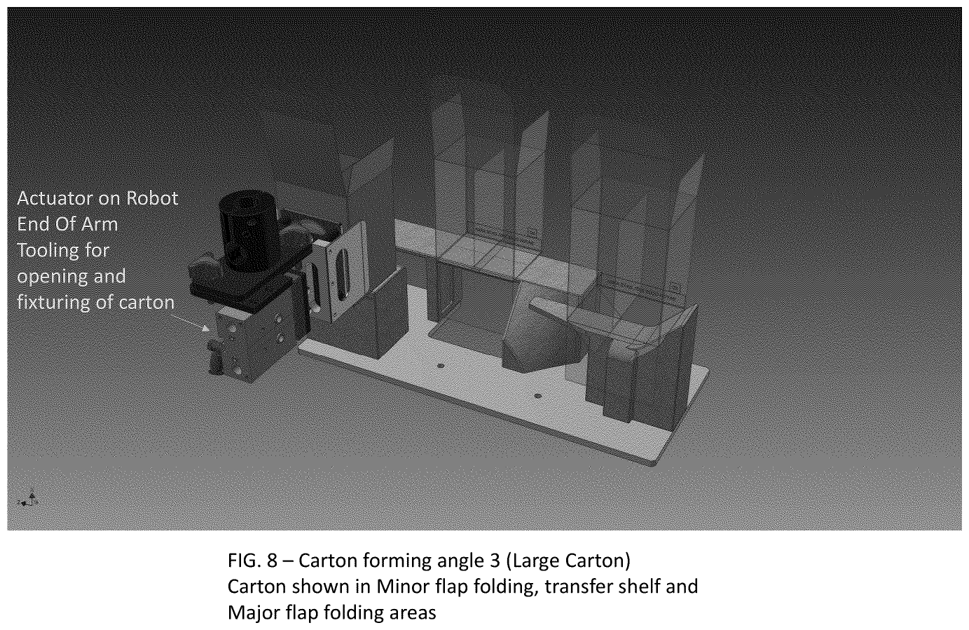

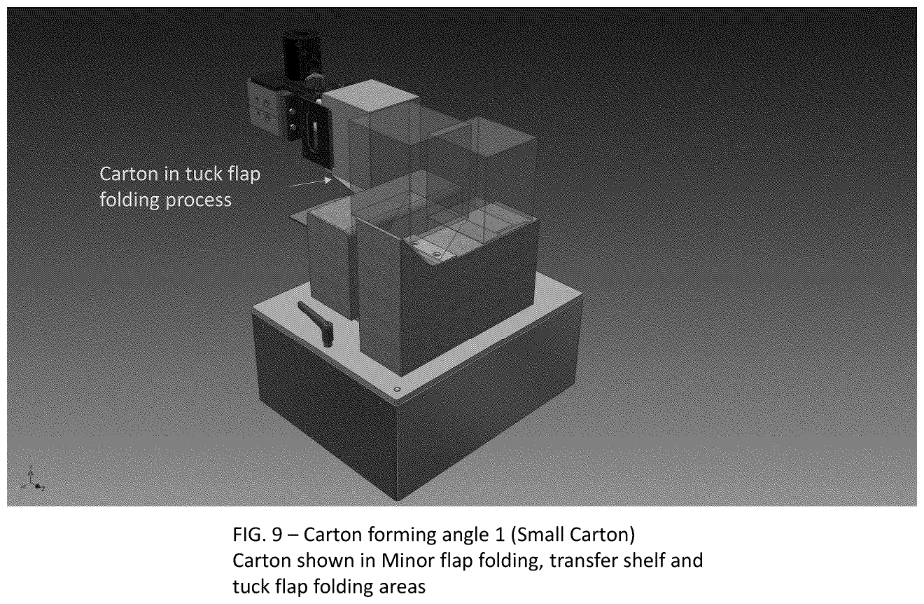

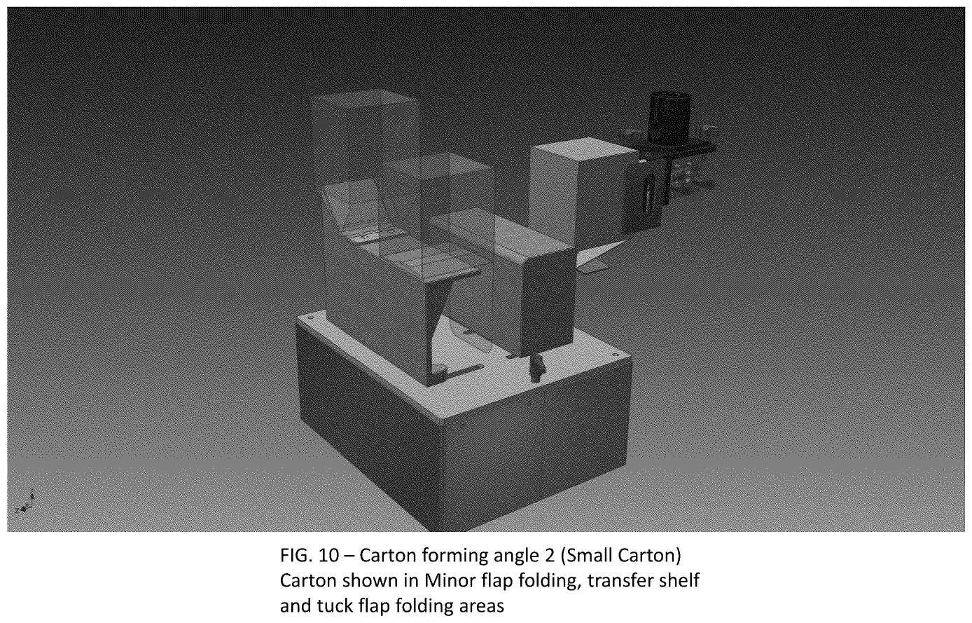

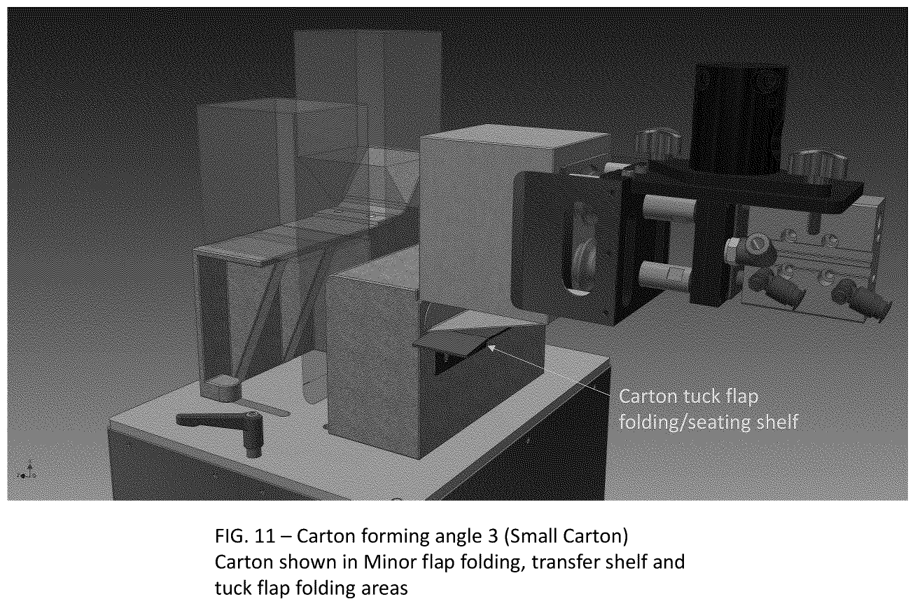

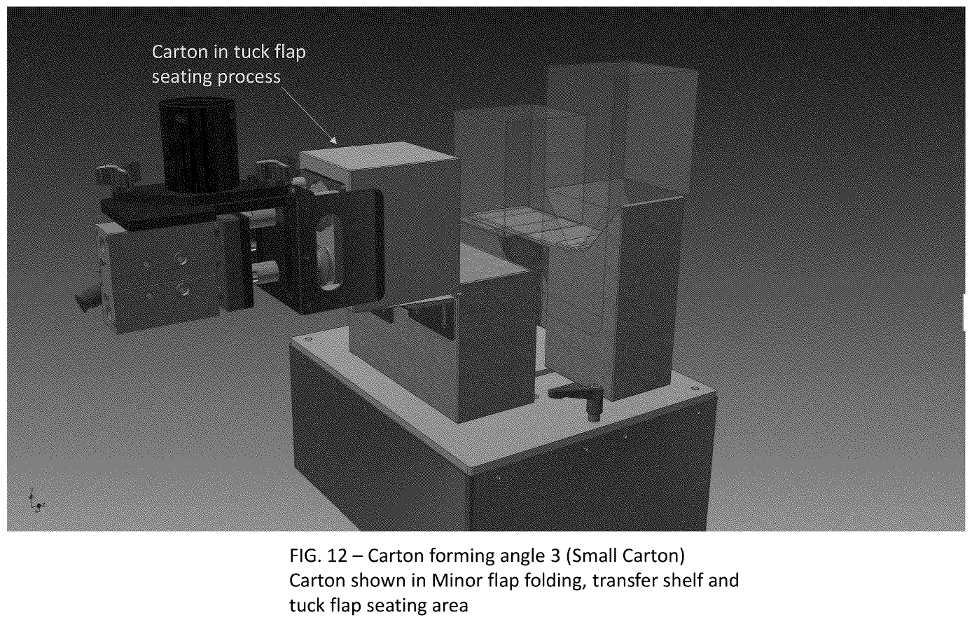

When programmed to carry out the process laid out in FIG. 1 and described above, robot arm 16 will move tooling 14 into position adjacent to a magazine 18 full of carton blanks 12. Vacuum cups 20 will be pneumatically actuated to engage a carton blank 12, as shown in FIG. 3. Tooling 14 will then extend using pneumatically actuated extension rods 22 with carton blank 12 remaining flat, as shown in FIG. 4, and then tooling 14 will open the carton blank 12, as shown in FIG. 5, and gripping plates 24 extending from arm 16 on each side of carton 12 engages and securely holds carton 12.

A sensor verifies whether a carton 12 has been successfully picked, and if not actuates an alarm (audible and/or visual such as an LED-not shown). If picked successfully, robot 10 moves carton 12 to minor flap station 30 and minor flaps 32 are folded by the robot 10 sweeping (moving about axis Y-Y) across the carton 12 to push minor flaps 32 into folded positions, thereby not requiring the use of ramps or other less stable fixtures and not requiring movement of the entire carton but rather just movement of the minor flaps themselves with the robot arm providing the necessary motive force to move the flaps.

Once the minor flaps 32 have been folded by robot arm 16, robot arm 16 grips the carton blank 12 and moves it across a transfer shelf 33 to the major flap fold station 34. Once positioned on the platform of major flap station 34, robot arm 16 again sweeps/moves along axis X-X to fold major flaps 36 and then robot arm 16 further moves down carton 12 to fold the tuck flap 38 and then to seat the tuck flap 38 and enclose carton 12. An optical sensor verifies the formation of carton 12 and if not properly formed actuates an alarm, and if verified, robot arm 16 picks carton 12 and places it on a discharge shelf 40.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

1. A method for robotically forming a carton using a robot, wherein the method comprises the steps of:
robotically picking a carton blank from a magazine, the carton blank comprising a carton body, at least two minor flaps and at least one major flap;
robotically forming the carton body from the carton blank;
robotically moving the carton to a minor flap folding station;
robotically folding the minor flaps of the carton with respect to the carton body;
robotically moving the carton to a major flap folding station;
robotically folding the major flaps of the carton with respect to the carton body; and
verifying that the carton is formed.

2. A system for robotically forming a carton, comprising:
a. a carton assembly station comprising:
i. a minor flap folding station having a minor flap platform upon which minor flaps of the carton can be robotically folded;
ii. a transfer shelf positioned adjacent the minor flap folding station and configured to support the carton with the minor flaps folded;
iii. a major flap folding station having a major flap platform upon which a major flap of the carton can be robotically folded; and
b. a robot having a processor with non-transitory memory in which is stored a program of instructions executable by the processor and which when executed cause the carton to be formed.

3. The system according to claim 2, wherein the program of instructions performs a method when executed, the method comprises the following steps:
robotically picking a carton blank from a magazine, the carton blank comprising a carton body, at least two minor flaps and at least one major flap;
robotically forming the carton body from the carton blank;
robotically moving the carton to a minor flap folding station;
robotically folding the minor flaps of the carton with respect to the carton body;
robotically moving the carton to a major flap folding station;
robotically folding the major flaps of the carton with respect to the carton body; and
verifying that the carton is formed.

4. The system of claim 3, wherein the step of robotically picking a carton blank from a magazine comprises pneumatically actuating a vacuum cup to engage the carton blank.

5. The system of claim 4, wherein the step of robotically forming the carton body from the carton blank comprises extending pneumatic extension rods while the carton blank is flat so that a set of tooling will open the carton blank while a pair of gripping plates engage and hold the carton body when the carton body forms.

6. The system of claim 5, wherein the step of robotically folding the minor flaps of the carton with respect to the carton body comprising sweeping the robot along a first axis to push the minor flaps into a folded position.

7. The system of claim 6, wherein the step of robotically folding the major flap of the carton with respect to the carton body comprises the robot moving the carton across a transfer shelf and then the robot sweeping the robot along a second axis to fold the major flaps.

8. The system of claim 7, further comprising the step of moving the robot further down the carton to fold and seat a tuck flap after moving along the second axis to fold the major flaps.

9. The method of claim 1, wherein the step of robotically picking a carton blank from a magazine comprises pneumatically actuating a vacuum cup to engage the carton blank.

10. The method of claim 9, wherein the step of robotically forming the carton body from the carton blank comprises extending pneumatic extension rods while the carton blank is flat so that a set of tooling will open the carton blank while a pair of gripping plates engage and hold the carton body when the carton body forms.

11. The method of claim 10, wherein the step of robotically folding the minor flaps of the carton with respect to the carton body comprising sweeping the robot along a first axis to push the minor flaps into a folded position.

12. The method of claim 11, wherein the step of robotically folding the major flap of the carton with respect to the carton body comprises the robot moving the carton across a transfer shelf and then sweeping the robot along a second axis to fold the major flaps.

13. The method of claim 12, further comprising the step of moving the robot further down the carton to fold and seat a tuck flap after moving the robot along the second axis to fold the major flaps.

14. The method of claim 13, wherein the carton blank is pre-glued.

15. The method of claim 14, further comprising the step of verifying whether the step of robotically picking a carton blank from a magazine was successful.

16. The method of claim 15, further comprising step of sounding an alarm if the step of verifying whether the step of robotically picking a carton blank from a magazine was successful determines that the carton blank was not successfully picked.

17. The method of claim 16, further comprising the step of triggering an alarm if the step of verifying that the carton is formed does not verify that a carton was formed.
